(19) United States
(12) Patent Application Publication
(10) Pub. No.: US 2011/0095671 A1
(43) Pub. Date: Apr. 28, 2011

(54) Light Emitting Diode Lamp Having A Larger Lighting Angle

(76) Inventor: Yu-Lin Chu, Tainan City (TW)

(21) Appl. No.: 12/606,349

(22) Filed: Oct. 27, 2009

(51) Int. Cl. H01J 61/52

(52) U.S. Cl. 313/46

(57) ABSTRACT

A light emitting diode lamp includes a light source and a heat radiating device combined with the light source. The light source includes a hollow substrate that is made of metal and has a substantially arcuate shape, a plurality of light emitting diodes mounted on an outer wall of the substrate, a plurality of heat conducting fins mounted on an inner wall of the substrate, and a light permeable cover mounted on the outer wall of the substrate to cover the light emitting diodes. Thus, the substrate of the light source is a substantially spherical body so that the light emitting diodes mounted on the outer wall of the substrate emit light beams outwardly in an irradiating manner and have a larger lighting angle to enhance the lighting effect.

### BACKGROUND OF THE INVENTION

1. Field of the Invention

The present invention relates to an illuminating apparatus and, more particularly, to a light emitting diode (L.E.D.) lamp.

2. Description of the Related Art

A conventional light emitting diode lamp comprises a light emitting diode, a first optical guide face and a second optical guide face. Thus, the light emitting diode can emit light outwardly to provide a lighting effect. However, the light emitting diode does not have a spherical shape so that the light emitting diode has a smaller lighting angle, thereby decreasing the lighting effect of the light emitting diode lamp. In addition, the light emitting diode lamp is not provided with a threaded base so that the light emitting diode lamp cannot replace a tungsten lamp or bulb.

### BRIEF SUMMARY OF THE INVENTION

In accordance with the present invention, there is provided a light emitting diode lamp, comprising a light source and a heat radiating device combined with the light source. The light source includes a hollow substrate that is made of metal and has a substantially arcuate shape, a plurality of light emitting diodes mounted on an outer wall of the substrate, a plurality of heat conducting fins mounted on an inner wall of the substrate, and a light permeable cover mounted on the outer wall of the substrate to cover the light emitting diodes.

The primary objective of the present invention is to provide a light emitting diode lamp having a larger lighting angle.

According to the primary objective of the present invention, the substrate of the light source is a substantially spherical body so that the light emitting diodes mounted on the outer wall of the substrate emit light beams outwardly in an irradiating manner and have a larger lighting angle to enhance the lighting effect.

According to another objective of the present invention, the heat radiating device is combined with the light source to provide a heat radiating effect to the light source efficiently.

According to a further objective of the present invention, the heat radiating member of the heat radiating device is provided with a threaded base so that the light emitting diode lamp can replace the traditional tungsten bulb.

According to a further objective of the present invention, the light permeable cover is mounted on the outer wall of the substrate to cover the light emitting diodes so that the light emitting diode lamp needs not to provide a light permeable piece additionally, thereby saving the costs of fabrication.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a partially broken perspective cross-sectional view of a light emitting diode lamp in accordance with the preferred embodiment of the present invention.

FIG. 2 is an exploded perspective view of the light emitting diode lamp as shown in FIG. 1.

FIG. 3 is a cross-sectional assembly view of the light emitting diode lamp taken along line 3-3 as shown in FIG. 2.

FIG. 4 is a side cross-sectional view of the light emitting diode lamp as shown in FIG. 1.

FIG. 5 is a partially broken perspective cross-sectional view of a light emitting diode lamp in accordance with another preferred embodiment of the present invention.

FIG. 6 is an exploded perspective view of a light emitting diode lamp in accordance with another preferred embodiment of the present invention.

FIG. 7 is a side cross-sectional assembly view of the light emitting diode lamp as shown in FIG. 6.

### DETAILED DESCRIPTION OF THE INVENTION

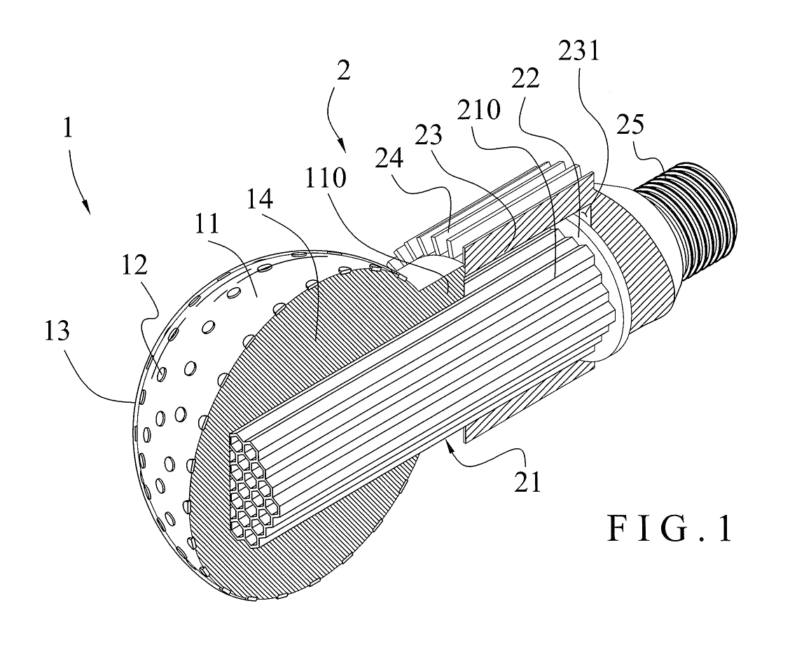

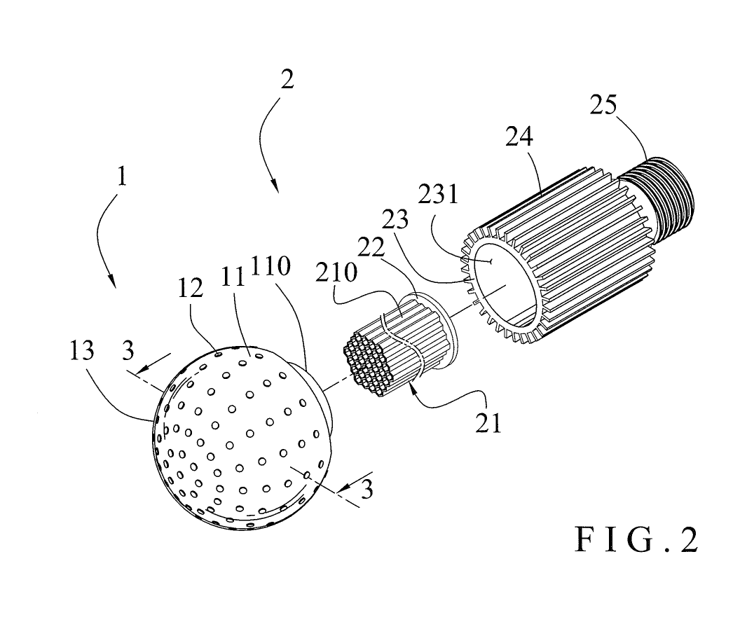

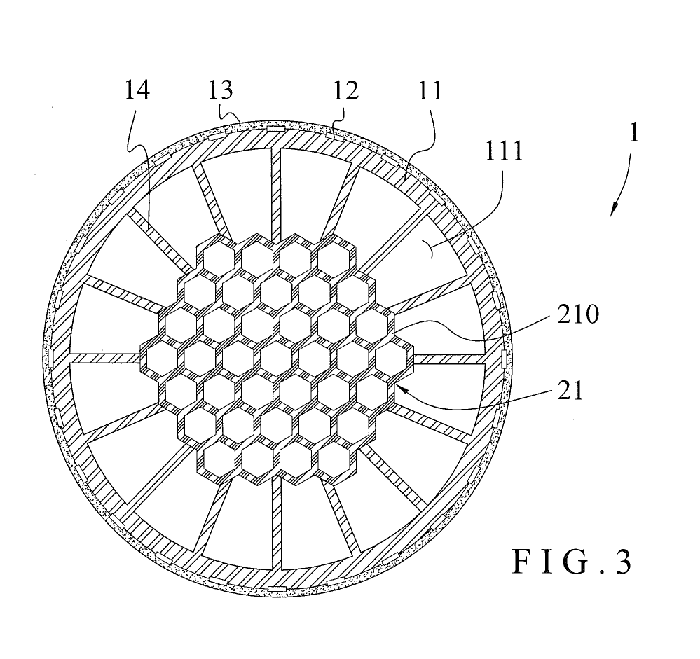

Referring to the drawings and initially to FIGS. 1-4, a light emitting diode (L.E.D.) lamp in accordance with the preferred embodiment of the present invention comprises a light source 1 and a heat radiating device 2 combined with the light source 1.

The light source 1 includes a hollow substrate 11 that is made of metal and has a substantially arcuate shape, a plurality of light emitting diodes 12 mounted on an outer wall of the substrate 11, a plurality of heat conducting fins 14 mounted on an inner wall of the substrate 11, and a light permeable cover 13 mounted on the outer wall of the substrate 11 to cover the light emitting diodes 12.

The substrate 11 of the light source 1 is a substantially spherical body. The substrate 11 of the light source 1 has a substantially C-shaped cross-sectional profile and has a cross-sectional angle of about 270 degrees (270°). The inner wall of the substrate 11 is provided with a heat dissipation space 111. The substrate 11 of the light source 1 has a periphery provided with an outwardly protruding open end portion 110. The cover 13 of the light source 1 is made of a heatproof light permeable gel and has a substantially C-shaped cross-sectional profile. Each of the light emitting diodes 12 of the light source 1 has a particle shape and is located between the cover 13 and the substrate 11 of the light source 1. The heat conducting fins 14 of the light source 1 are located in the heat dissipation space 111 of the substrate 11 and are arranged in a radiating manner. Each of the heat conducting fins 14 of the light source 1 is made of metal.

The heat radiating device 2 includes a hollow heat radiating member 23 contacting with the substrate 11 of the light source 1, a plurality of heat radiating ribs 24 mounted on an outer wall of the heat radiating member 23, an elongate heat conducting module 21 having a first end extended into the substrate 11 of the light source 1 and contacting with the heat conducting fins 14 of the light source 1 and a second end extended into the heat radiating member 23, and a heat conducting plate 22 mounted on the second end of the heat conducting module 21 and contacting with the heat radiating member 23.

The heat radiating member 23 of the heat radiating device 2 is made of metal and has a first end contacting with the substrate 11 of the light source 1 and a second end provided with a threaded base 25. The first end of the heat radiating member 23 abuts the open end portion 110 of the substrate 11. The heat radiating member 23 of the heat radiating device 2 has a substantially cylindrical shape and has an inner wall provided with a receiving chamber 231 to receive the heat conducting plate 22 and the second end of the heat conducting module 21. The receiving chamber 231 of the heat radiating member 23 has a circular shape.

The heat radiating ribs 24 of the heat radiating device 2 are arranged on the heat radiating member 23 in a radiating manner. Each of the heat radiating ribs 24 of the heat radiating device 2 has an elongate shape and extends through a whole length of the heat radiating member 23. Each of the heat radiating ribs 24 of the heat radiating device 2 is made of metal.

The heat conducting plate 22 of the heat radiating device 2 is made of metal. The heat conducting plate 22 of the heat radiating device 2 has a circular shape and has a size flush with that of the receiving chamber 231 of the heat radiating member 23 so that the heat conducting plate 22 of the heat radiating device 2 is fully in contact with the inner wall defining the receiving chamber 231 of the heat radiating member 23.

The heat conducting module 21 of the heat radiating device 2 has a beehive shape and has a size smaller than that of the receiving chamber 231 of the heat radiating member 23 so that the heat conducting module 21 of the heat radiating device 2 is spaced from the inner wall defining the receiving chamber 231 of the heat radiating member 23. The heat conducting module 21 of the heat radiating device 2 is made of metal and consists of a plurality of elongate polygonal pipes. The first end of the heat conducting module 21 of the heat radiating device 2 is extended through the open end portion 110 of the substrate 11 into the heat dissipation space 111 of the substrate 11 so that each of the heat conducting fins 14 of the light source 1 is located between and in contact with the substrate 11 of the light source 1 and the heat conducting module 21 of the heat radiating device 2. Preferably, the first end of the heat conducting module 21 of the heat radiating device 2 extends a whole length of the heat dissipation space 111 of the substrate 11.

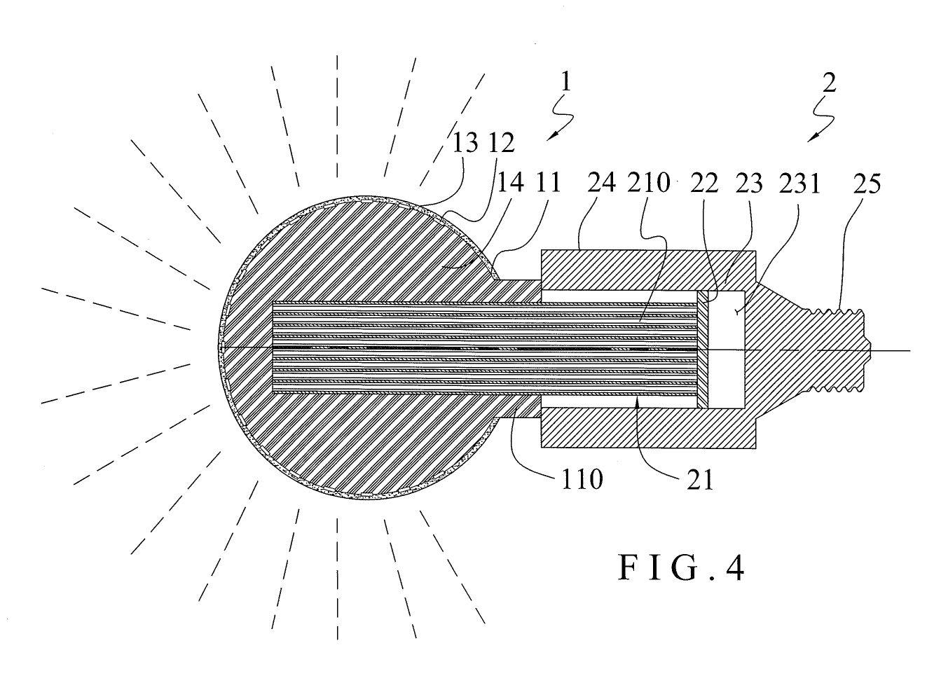

In operation, referring to FIG. 4 with reference to FIGS. 1-3, the substrate 11 of the light source 1 is a substantially spherical body so that the light emitting diodes 12 mounted on the outer wall of the substrate 11 emit light beams outwardly in an irradiating manner as shown in FIG. 4 and have a larger lighting angle to enhance the lighting effect. At this time, the substrate 11 contacts with the heat conducting fins 14 which contact with the heat conducting module 21 which contacts with the heat conducting plate 22 which contacts with the heat radiating member 23 which contacts with the heat radiating ribs 24. Thus, the heat produced by the light emitting diodes 12 of the light source 1 is in turned transmitted by the substrate 11 of the light source 1, the heat conducting fins 14 of the light source 1, the heat conducting module 21 of the heat radiating device 2, the heat conducting plate 22 of the heat radiating device 2, the heat radiating member 23 of the heat radiating device 2 to the heat radiating ribs 24 of the heat radiating device 2 and is carried outwardly from the heat radiating ribs 24 of the heat radiating device 2 to the ambient environment so as to achieve a heat dissipation effect.

In such a manner, most of the heat on the substrate 11 is transmitted directly through the heat conducting fins 14 to the heat conducting module 21 of the heat radiating device 2 so that the heat conducting fins 14 provides a heat conduction to enhance the heat radiating effect. At this time, a part of the heat on the substrate 11 is transmitted indirectly through the heat dissipation space 111 of the substrate 11 to the heat conducting module 21 of the heat radiating device 2 so that the heat dissipation space 111 of the substrate 11 provides a heat convection to enhance the heat radiating effect.

In the preferred embodiment of the present invention, the substrate 11, the heat conducting module 21, the heat conducting plate 22, the heat radiating member 23 and the heat radiating ribs 24 are made of metal to conduct and dissipate the heat easily and quickly. In addition, the substrate 11 of the light source 1 has a specific heat ratio greater than that of the heat conducting module 21 of the heat radiating device 2, the heat conducting module 21 of the heat radiating device 2 has a specific heat ratio greater than that of the heat conducting plate 22 of the heat radiating device 2, the heat conducting plate 22 of the heat radiating device 2 has a specific heat ratio greater than that of the heat radiating member 23 of the heat radiating device 2, and the heat radiating member 23 of the heat radiating device 2 has a specific heat ratio greater than that of each of the heat radiating ribs 24 of the heat radiating device 2 so as to enhance the heat radiating effect of the lamp. For example, the substrate 11 is made of aluminum which has a specific heat ratio of 900, and the heat conducting module 21 is made of copper which has a specific heat ratio of 385.

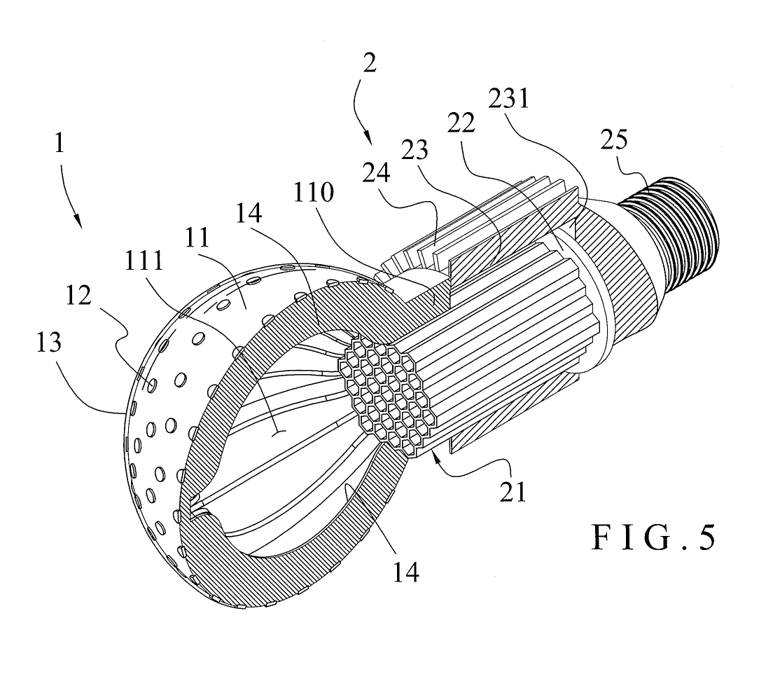

As shown in FIG. 5, the first end of the heat conducting module 21 of the heat radiating device 2 is extended into the open end portion 110 of the substrate 11 and is spaced from the heat dissipation space 111 of the substrate 11 so that each of the heat conducting fins 14 of the light source 1 only has an end portion in contact with the heat conducting module 21 of the heat radiating device 2.

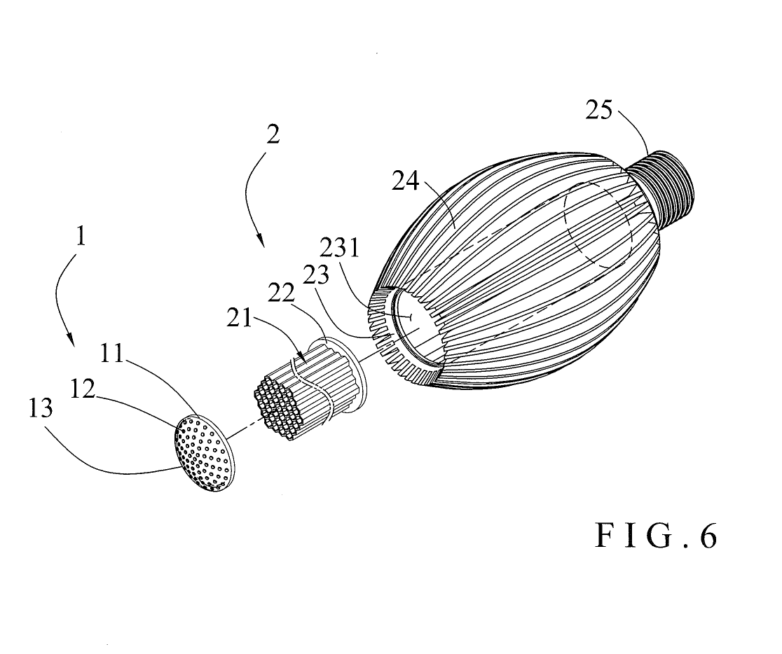

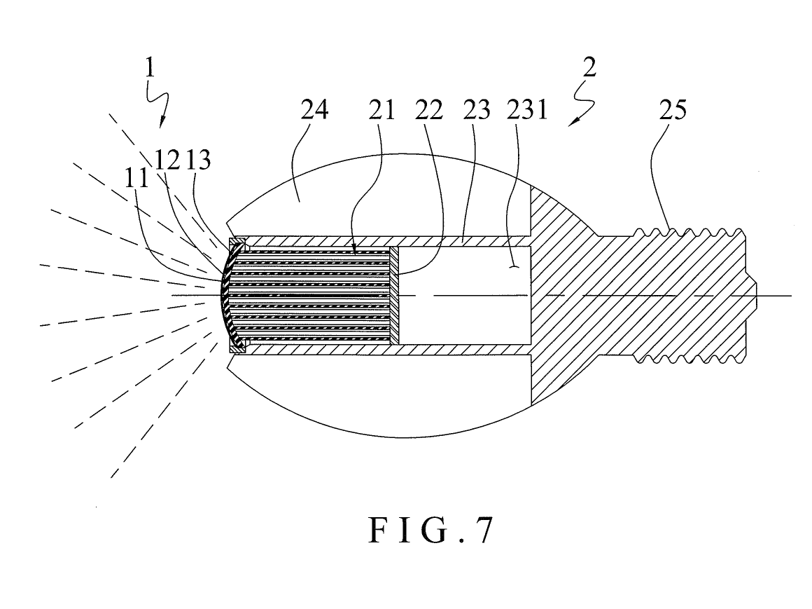

As shown in FIGS. 6 and 7, the substrate 11 of the light source 1 has a substantially arc-shaped cross-sectional profile and has a cross-sectional angle of about 120 degrees (120°). Thus, the light emitted from the light emitting diodes 12 of the light source 1 has a smaller and focused lighting angle to enhance the brightness.

Accordingly, the substrate 11 of the light source 1 is a substantially spherical body so that the light emitting diodes 12 mounted on the outer wall of the substrate 11 emit light beams outwardly in an irradiating manner as shown in FIG. 4 and have a larger lighting angle to enhance the lighting effect. In addition, the heat radiating device 2 is combined with the light source 1 to provide a heat radiating effect to the light source 1 efficiently. Further, the heat radiating member 23 of the heat radiating device 2 is provided with a threaded base 25 so that the light emitting diode lamp can replace the traditional tungsten bulb. Further, the light permeable cover 13 is mounted on the outer wall of the substrate 11 to cover the light emitting diodes 12 so that the light emitting diode lamp needs not to provide a light permeable piece additionally, thereby saving the costs of fabrication.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A light emitting diode lamp, comprising:
a light source;
a heat radiating device combined with the light source; wherein:
the light source includes:
a hollow substrate that is made of metal and has a substantially arcuate shape;
a plurality of light emitting diodes mounted on an outer wall of the substrate;
a plurality of heat conducting fins mounted on an inner wall of the substrate; and
a light permeable cover mounted on the outer wall of the substrate to cover the light emitting diodes.

2. The light emitting diode lamp of claim 1, wherein the substrate of the light source is a substantially spherical body.

3. The light emitting diode lamp of claim 1, wherein the heat radiating device includes:
a hollow heat radiating member contacting with the substrate of the light source;
a plurality of heat radiating ribs mounted on an outer wall of the heat radiating member;
an elongate heat conducting module having a first end extended into the substrate of the light source and contacting with the heat conducting fins of the light source and a second end extended into the heat radiating member; and
a heat conducting plate mounted on the second end of the heat conducting module and contacting with the heat radiating member.

4. The light emitting diode lamp of claim 3, wherein the heat radiating member of the heat radiating device has a first end contacting with the substrate of the light source and a second end provided with a threaded base.

5. The light emitting diode lamp of claim 3, wherein the heat radiating member of the heat radiating device has an inner wall provided with a receiving chamber to receive the heat conducting plate and the second end of the heat conducting module.

6. The light emitting diode lamp of claim 3, wherein the heat conducting module of the heat radiating device has a beehive shape.

7. The light emitting diode lamp of claim 6, wherein the heat conducting module of the heat radiating device consists of a plurality of elongate polygonal pipes.

8. The light emitting diode lamp of claim 3, wherein
the heat radiating member of the heat radiating device is made of metal;
each of the heat radiating ribs of the heat radiating device is made of metal;
the heat conducting plate of the heat radiating device is made of metal;
the heat conducting module of the heat radiating device is made of metal.

9. The light emitting diode lamp of claim 8, wherein
the substrate of the light source has a specific heat ratio greater than that of the heat conducting module of the heat radiating device;
the heat conducting module of the heat radiating device has a specific heat ratio greater than that of the heat conducting plate of the heat radiating device;
the heat conducting plate of the heat radiating device has a specific heat ratio greater than that of the heat radiating member of the heat radiating device;
the heat radiating member of the heat radiating device has a specific heat ratio greater than that of each of the heat radiating ribs of the heat radiating device.

10. The light emitting diode lamp of claim 3, wherein
the inner wall of the substrate is provided with a heat dissipation space;
the heat conducting fins of the light source are located in the heat dissipation space of the substrate.

11. The light emitting diode lamp of claim 5, wherein
the heat radiating member of the heat radiating device has a substantially cylindrical shape;
the receiving chamber of the heat radiating member has a circular shape.
the heat conducting plate of the heat radiating device has a circular shape.

12. The light emitting diode lamp of claim 5, wherein
the heat conducting plate of the heat radiating device has a size flush with that of the receiving chamber of the heat radiating member;
the heat conducting plate of the heat radiating device is fully in contact with the inner wall defining the receiving chamber of the heat radiating member.

13. The light emitting diode lamp of claim 5, wherein
the heat conducting module of the heat radiating device has a size smaller than that of the receiving chamber of the heat radiating member;
the heat conducting module of the heat radiating device is spaced from the inner wall defining the receiving chamber of the heat radiating member.

14. The light emitting diode lamp of claim 1, wherein
each of the light emitting diodes of the light source has a particle shape;
each of the light emitting diodes of the light source is located between the cover and the substrate of the light source.

15. The light emitting diode lamp of claim 10, wherein
the substrate of the light source has a substantially C-shaped cross-sectional profile;
the substrate of the light source has a periphery provided with an outwardly protruding open end portion;
the first end of the heat radiating member abuts the open end portion of the substrate.

16. The light emitting diode lamp of claim 15, wherein
the first end of the heat conducting module of the heat radiating device is extended through the open end portion of the substrate into the heat dissipation space of the substrate;
each of the heat conducting fins of the light source is located between and in contact with the substrate of the light source and the heat conducting module of the heat radiating device.

17. The light emitting diode lamp of claim 15, wherein
the first end of the heat conducting module of the heat radiating device is extended into the open end portion of the substrate and is spaced from the heat dissipation space of the substrate;
each of the heat conducting fins of the light source only has an end portion in contact with the heat conducting module of the heat radiating device.

18. The light emitting diode lamp of claim 15, wherein the cover of the light source has a substantially C-shaped cross-sectional profile.

19. The light emitting diode lamp of claim 3, wherein
the heat conducting fins of the light source are arranged in a radiating manner;
the heat radiating ribs of the heat radiating device are arranged on the heat radiating member in a radiating manner;
each of the heat radiating ribs of the heat radiating device has an elongate shape and extends through a whole length of the heat radiating member.

20. The light emitting diode lamp of claim 10, wherein the first end of the heat conducting module of the heat radiating device extends a whole length of the heat dissipation space of the substrate.
